(19) United States
(12) Patent Application Publication
(10) Pub. No.: US 2020/0293018 A1
(43) Pub. Date: Sep. 17, 2020

(54) TIME SERIES DATA MONITORING SYSTEM AND TIME SERIES DATA MONITORING METHOD

(71) Applicant: HITACHI, LTD., Tokyo (JP)

(72) Inventors: Shinichi TSUNOO, Tokyo (JP); Yoshiyuki TAJIMA, Tokyo (JP); Daisuke YAMAZAKI, Tokyo (JP)

(73) Assignee: HITACHI, LTD., Tokyo (JP)

(21) Appl. No.: 16/807,707

(22) Filed: Mar. 3, 2020

(30) Foreign Application Priority Data
Mar. 14, 2019 (JP) 2019-047410

(51) Int. Cl. G05B 19/406

(52) U.S. Cl. CPC G05B 19/406; G05B 2219/37514

(57) ABSTRACT

A time series data monitoring system includes: a series pattern candidate generating unit that generates series pattern candidates included in time series data obtained from a monitored system using the time series data and a prediction model of the time series data; and a series pattern generating unit that classifies the series pattern candidates generated by the series pattern candidate generating unit and outputs, as a series pattern of the time series data, a candidate satisfying a predetermined condition among the classified series pattern candidates.

### BACKGROUND OF THE INVENTION

### 1. Field of the Invention

The present invention relates to a technique of monitoring time series data.

### 2. Description of Related Art

When a plant facility or a device in the power Generation field or the industrial field is broken, the plant facility or the device becomes inactive and the earnings decrease. Therefore, it is necessary that the state of the plant is monitored to identify an abnormality or a prior warning thereof. During the state monitoring, a temperature, a pressure, and the like obtained from a sensor present in the plant are collected, and the collected data is displayed and checked.

For example, JP-A-2017-156942 discloses a configuration in which a plurality of motif groups are generated by acquiring measured sensor data in a time series, converting the sensor data into a character string, detecting a partial character string having an appearance frequency of a predetermined value or more as a motif from the converted character string, and grouping similar motifs within a predetermined distance among a plurality of detected motifs. Further, based on time positions at which the detected motifs appear in the time-series character string, a group of motif groups that collectively appears in a predetermined range in a time series are detected among motif groups including the motifs such that not only a short-term state but also a long-term state that collectively shows the short-term states are detected from the time series data and checked.

However, in JP-A-2017-156942, the results change depending on the conversion of the time series data into the character string. In order to appropriately extract a time-series pattern, it is necessary to appropriately adjust parameters such as a duration, a range of value, or an appearance frequency, but this adjustment is difficult. Therefore, the time-series pattern cannot be appropriately extracted at all times.

### SUMMARY OF THE INVENTION

An object of the present invention is to provide a time series data monitoring system capable of appropriately extracting a time-series pattern and presenting the time-series pattern to a user and a time series data monitoring method.

According to one aspect of the present invention for achieving the object, there is provided a time series data monitoring system including: a series pattern candidate generating unit that generates series pattern candidates included in time series data obtained from a monitored system using the time series data and a prediction model of the time series data; and a series pattern generating unit that classifies the series pattern candidates generated by the series pattern candidate generating unit and outputs, as a series pattern of the time series data, a candidate satisfying a predetermined condition among the classified series pattern candidates.

According to the aspect of the present invention, a time-series pattern can be appropriately extracted and can be presented to a user.

### BRIEF DESCRIPTION OF THE DRAWINGS

FIG. 1 is a diagram illustrating a configuration example of a monitoring system that monitors time series data;

FIG. 2 is a diagram illustrating a configuration example of hardware of a calculator as an example of a data monitoring device;

FIG. 3 is a diagram illustrating an example of time series data;

FIG. 4 is a diagram illustrating an example of intermediate data for generating a series pattern candidate;

FIG. 5 is a diagram illustrating an example of series pattern data representing a series pattern candidate ID and a pattern ID;

FIG. 6 is a diagram illustrating an example of search result data;

FIG. 7 is a diagram illustrating an example of a list of parameters;

FIG. 8 is a flowchart illustrating an example of a sensor selection and model learning process;

FIG. 9 is a flowchart illustrating an example of a series pattern candidate generation process;

FIG. 10 is a flowchart illustrating an example of a generation process of a series pattern generating unit;

FIG. 11 is a flowchart illustrating an example of a search process of a search query generating unit;

FIG. 12 is a diagram illustrating an example of a series pattern candidate display screen output from the series pattern candidate generating unit;

FIG. 13 is a diagram illustrating an example of a series pattern display screen output from a series pattern generating unit;

FIG. 14 is a diagram illustrating an example of a data search/extraction screen displayed by a search result extracting unit;

FIG. 15 is a diagram illustrating a search query generation screen displayed by the search query generating unit; and

FIG. 16 is a diagram illustrating another configuration example of the monitoring system that monitors time series data.

### DESCRIPTION OF EMBODIMENTS

Hereinafter, an embodiment of the present invention will be described with reference to the drawings. The following description and drawings are merely exemplary for describing the present invention and will not be repeated or simplified appropriately to clarify the description. The present invention can be implemented in other various embodiments. Unless specified otherwise, the number of each of components may be one or plural.

For easy understanding of the present invention, the position, size, shape, range, and the like of each of the components illustrated in the drawings do not necessarily represent the actual ones. Therefore, the present invention is not necessarily limited to the position, size, shape, range, and the like illustrated in the drawings.

In the following description, various information may be described using the expression “table”, “list”, or the like. However, various information may be expressed using a data structure other than “table” or “list”. In order to show that various information do not depend on a data structure, “XX table”, “XX list”, or the like will also be referred to as “XX information”. In order to describe identification information, the expressions “identification information”, “identifier”, “name”, “ID”, “number”, and the like are used and can be replaced with each other.

When a plurality of components having the same or identical function are present, different suffixes may be added to the same reference numeral in the description. In this case, when it is not necessary to distinguish between the components, the suffixes are removed in the description.

In addition, in the following description, a process may be executed by executing a program. In this case, by executing a program using a processor (for example, a CPU or a GPU), a predetermined program is executed while appropriately using a storage resource (for example, a memory) and/or an interface device (for example, a communication port). Therefore, the subject of the process may be the processor. Likewise, the subject of a process that is executed by executing a program may be a controller, a device, a system, a calculator, or a node that includes processor. The subject of a process that is executed by executing a program may be an arithmetic unit or may include a dedicated circuit (for example, a FPGA or an ASIC) that executes a specific process.

The program may be installed from a program source into a device such as a calculator. The program source may be, for example, a program distribution server or a storage medium that is readable by a calculator. When the program source is the program distribution server, the program distribution server includes a processor and a storage resource that stores a program to be distributed, and the processor of the program distribution server may distribute the program to be distributed to another calculator. In addition, in the following description, two or more programs may be implemented as one program, or one program may be implemented as two or more programs.

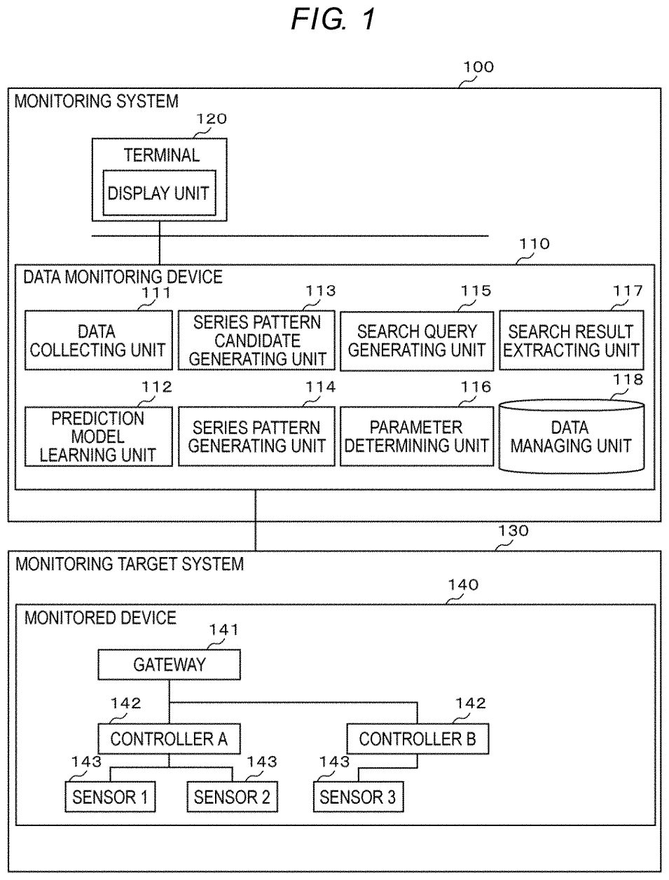

FIG. 1 is a diagram illustrating a configuration example of a monitoring system 100 according to an embodiment of the present invention that monitors for time series data. Specifically, although described below in detail, a process of the monitoring system 100 can be divided into a monitoring target selection and model learning phase, a series pattern generation phase, and a monitoring phase. In the monitoring target selection and model learning phase, a sensor as a monitoring target is selected from data output from a monitoring target system 130, and a prediction model used for generating series pattern candidates is learned. In the series pattern generation phase, series pattern candidates based on prediction results obtained using the prediction model are generated, similar series pattern candidates are clustered, a representative series pattern candidate is notified to a user as a series pattern, and related information thereof is displayed. In the monitoring phase, a data section of monitoring target data generated by the user based on the series pattern is notified, and related information thereof is displayed.

As illustrated in FIG. 1, the monitoring system 100 includes a data monitoring device 110 and a terminal 120. The data monitoring device 110 outputs: a series pattern extraction result that is extracted from time series data obtained from the monitoring target system 130; and a search result (data part similar to a monitoring pattern) based on a monitoring pattern designated by the user. The terminal 120 displays a result output from the data monitoring device 110.

The monitoring target system 130 includes one or more monitored devices 140. The monitored device 140 is a device constituting a field system such as a production line or a plant. For example, the monitored device 140 includes a gateway 141, a controller 142, and a sensor 143. In the monitored device 140, sensor data detected by the sensor 143 is converted into time series data by the controller 142, and a data collecting unit 111 of the monitoring system 100 collects the converted time series data via the gateway 141. Each of the gateway 141, the controller 142, and the sensor 143 can be implemented using a general device as hardware.

The data monitoring device 110 and the terminal 120 may be connected via a network such as a LAN. The respective monitoring target system 130 may be connected via a local area network (LAN) or a wide area network (WAN) such as a world wide web (WWW). Further, the number of each of the components may be increased or decreased, and the respective components may be connected via one network or in a hierarchical manner. For example, the data monitoring device 110 may be configured with a plurality of devices. In addition, for example, the data monitoring device 110 may be implemented on the same hardware as that of the terminal 120. Further, for example, one or more monitored devices 140 may share hardware with the data monitoring device 110 or the terminal 120.

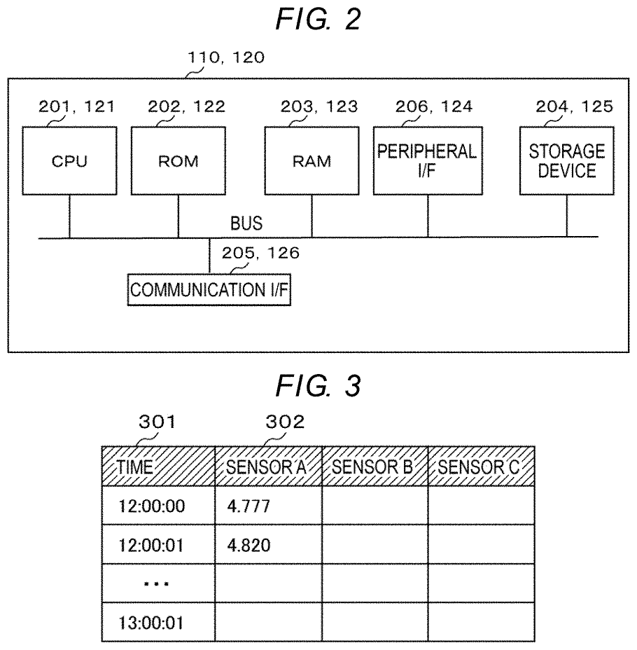

FIG. 2 is a diagram illustrating a configuration example of hardware of a calculator as an example of the data monitoring device 110. Hereinafter, the data monitoring system 100 will be described with reference to FIGS. 1 and 2.

For example, as hardware such as a server, the data monitoring device 110 is configured with a general information processing device. As functions, the data monitoring device 110 includes the data collecting unit 111, a prediction model learning unit 112, a series pattern candidate generating unit 113, a series pattern generating unit 114, a search query generating unit 115, a parameter determining unit 116, a search result extracting unit 117, and a data managing unit 118. These functions may be implemented by a CPU 201 included in the data monitoring device 110 reading a program stored in a ROM 202 or a storage device 204 (external storage device) to a RAM 203 and controlling an external input device such as a mouse or a keyboard and an external output device such as a display via a communication I/F 205 and a peripheral I/F 206. A specific process to be executed by each of the units will be described below.

In addition, for example, the terminal 120 is configured with an information processing terminal such as a personal computer (PC) and includes a display unit 121 as a function. The function of the display unit 121 may be implemented by a CPU 121 included in the terminal 120 reading a program stored in a ROM 122 or a storage device 125 (external storage device) to a RAM 123 and controlling an external input device such as a mouse or a keyboard and an external output device such as a display via a communication I/F 126 and a peripheral I/F 124. The function of the display unit 121 may be provided in the data monitoring device 110. A specific process to be executed by the unit will be described below.

FIG. 3 is a diagram illustrating an example of time series data that is handled by this system. For example, the time series data is collected from the monitoring target system 130 by the data collecting unit 111 of the monitoring system 100. In the following description, the monitoring system 100 collects the time series data. However, the time series data may be transmitted by the monitoring target system 130 and may be received by the monitoring system 100.

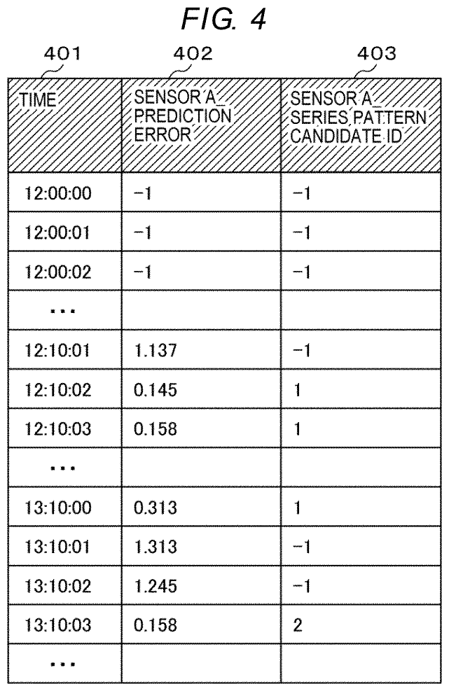

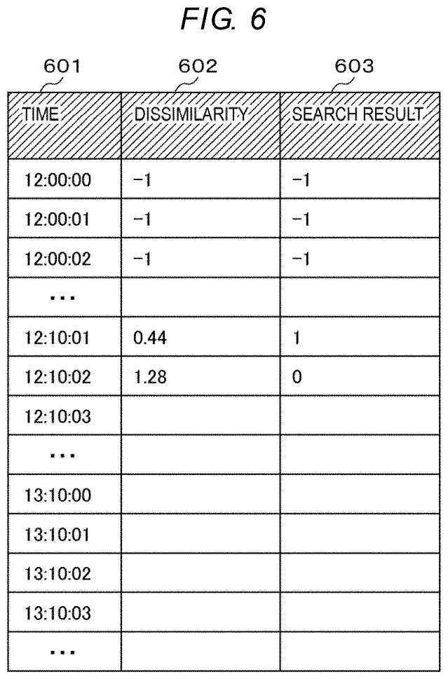

As illustrated in FIG. 3, for example, the time series data includes one or more columns and one or more records . FIG. 3 illustrates an example in which data output in comma-separated values (CSV) format is shown in tabular form. Each column forming the time series data includes a time 301 and a sensor 302 (in FIG. 3, three sensors A to C) and is associated with one record. The record is internal information stored in the monitored device 140 or data obtained from the sensor, and is operation data of the monitored device 140 that is periodically collected by the monitoring system 100. For example, FIG. 3 illustrates that 4.777 is collected as a value of the sensor A at the time of 12:00. When the time series data is data that is periodically collected or measured, the time series data may be managed using an index number instead of the time 301 (the same can be applied to the cases of FIGS. 4 and 6).

FIG. 4 is a diagram illustrating an example of intermediate data for generating a series pattern candidate. The intermediate data is generated for each sensor and is data in which a prediction error and a series pattern candidate are associated with each other. The prediction error is expressed as an absolute value of a difference between a prediction result output using the prediction model and actual sensor data illustrated in FIG. 3 For a record that cannot be predicted by calculation, a value of the prediction error may be filled with a value (for example, −1) representing outside of the target range or may not include an output result.

As illustrated in FIG. 4, the intermediate data includes a time 401, a prediction error 402, and a series pattern candidate ID 403. The series pattern candidate ID 403 is identification information for identifying partial series data that is partial time series data of time series data. The series pattern candidate ID 403 assigns the same ID of 0 or more to a series of records in which the prediction error is less than or equal to a threshold θ continuously L times. For example, for a record that cannot be predicted by calculation or a record in which the prediction error is more than the threshold θ, “−1” is set to the ID 403.

For example, FIG. 4 shows that records from the time of 12:10:02 to the time of 13:10:00 are partial series data as series pattern candidates and 1 is set to the series pattern candidate ID. In the description of the embodiment, each sensor includes the intermediate data. However, a sensor ID for identifying the sensor is assigned in association with the time 401, the prediction error 402, and the series pattern candidate ID 403, and one intermediate data includes the prediction error and the series pattern candidate ID for each sensor ID. For example, these data may be stored and managed in the data managing unit 118 configured with a storage device such as a hard disk drive (HDD).

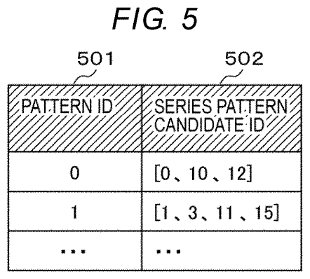

FIG. 5 is a diagram illustrating an example of series pattern data representing a series pattern candidate ID and a pattern ID. As illustrated in FIG. 5, the series pattern data includes the pattern ID and the series pattern candidate ID. The pattern ID is a number for identifying a cluster classified by clustering using dissimilarity that is calculated between the partial series data corresponding to the series pattern candidate ID. For example, FIG. 5 illustrates that a series pattern identified by the pattern ID “0” includes partial series data identified by the series pattern candidate IDs “0”, “10”, and “12”, and both the data are associated with each other. These data may be stored and managed in the data managing unit 118.

FIG. 6 a diagram illustrating an example of search result data. The search result data is generated for each search query and is data in which dissimilarity and a search result are associated with each other. The dissimilarity is dissimilarity between the search query and the partial series data as the series pattern. In the embodiment, the dissimilarity between the search query and the partial series data is used. However, similarity may be used. That is, the search result data may be information regarding similarity between the search query and the partial series data.

The search result may be expressed as a value representing whether or not the search result searched using the search query can be acquired. In FIG. 6, for a record whose score cannot be calculated, the value of the search result may be set to a value (for example, −1) representing the outside of the target range or may not be included in the value output results. These data may be managed in the data managing unit 118.

As illustrated in FIG. 6, the search result data includes a time 601, a dissimilarity 602, and a search result 603. The search result 603 is information regarding a value representing whether or not the search result can be acquired. When the search result 603 is hit by the search query, a predetermined value (for example, 1) is set. When the search result 603 is hit by the search query and satisfies a threshold ϕ, a predetermined value (for example, 1) is set. When the search result 603 is not hit by the search query and does not satisfy the threshold ϕ, a predetermined value (for example, 0) is set. Further, for a record that cannot be searched by calculation or a record in which the dissimilarity is more than the threshold ϕ by a predetermined value, the search result 603 is set to “−1”.

For example, FIG. 6 illustrates that partial series data as a series pattern candidate at the time of 12:10:01 is data (for example, dissimilarity 0.44<threshold ϕ=1) that is hit by the search query and satisfies the threshold ϕ. In addition, Fia. 6 illustrates that partial series data as a series pattern candidate at the time of 12:10:02 is data (for example, dissimilarity 1.23≥threshold ϕ=1) that is not hit by the search query and does not satisfy the threshold ϕ.

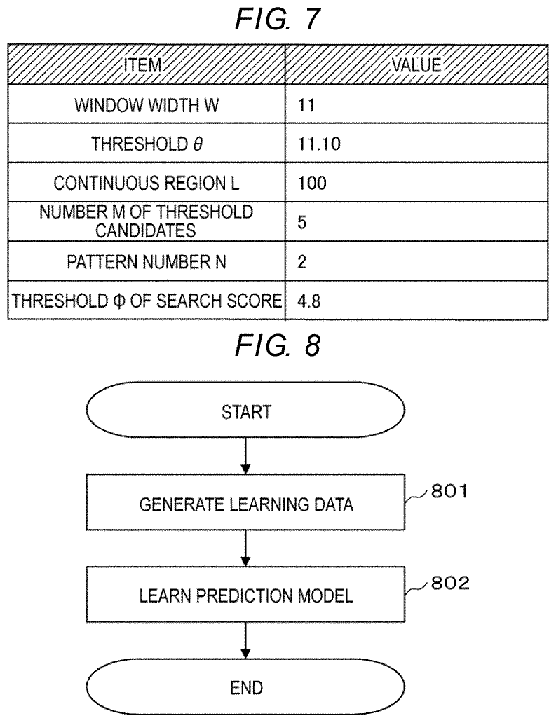

FIG. 7 is a diagram illustrating an example of a list of parameters used in this system. In FIG. 7, as the parameters, a window width, a threshold, a continuous region, the number of threshold candidates, a pattern number, and a threshold of a search score are predetermined. A window width W is a window width of a sub-sequence when the prediction model is generated. The threshold θ is a threshold of the prediction error for determining a series pattern candidate. The continuous region L is a threshold of the number of data for determining a predictable continuous region. Hereinafter, partial series data in which the prediction error is less than or equal to the threshold θ and a data length of the threshold θ or less is more than or equal to L is set as a series pattern candidate.

The number M of threshold candidates is the number of candidates of the threshold θ and can be determined, for example, by k-means. The number M of threshold candidates may be presented to the user by being displayed by the display unit. In a method of generating the threshold candidate, for example, the series pattern candidates maybe classified into a M number of classifications depending on the sizes of prediction error values, and the smallest value in each of the classifications may be set as a candidate.

The pattern number N is the number of patterns when the series patterns are clustered and represents that the series pattern candidates are clustered into a N number of clusters. The threshold ϕ of the search score is a threshold of the dissimilarity for determining whether or not the data is hit during search, and when the search score is less than or equal to the threshold ϕ, it is determined that the search score is hit These parameters are set by the parameter determining unit 116, for example, based on an instruction output from the user via the terminal 120.

FIG. 8 is a flowchart illustrating an example of a sensor selection and model learning process. Hereinafter, a prediction model f of the time series data is configured with a neural network, the output (prediction result) of the prediction model f of the time series data is represented by y\hat{ }=f(x), a prediction source is represented by a sub-sequence having a window width W×(t)={d_((2t−W+1)/2), . . . , d_t, . . . , d_((2t+W−1)/2)}, a prediction destination is represented by a sub-sequence having a window width W y(t)=x(t+W)={d_((2t+W+1)/2), . . . , d_(t+W), . . . , d_((2t+3W−1)/2)}, and a learning loss function as a prediction error is represented by error sum of squares E=½Σ[(y\hat{ }−y)]\hat{ }2. As the prediction model f of the time series data, for example, polynomial regression that is a statistical method may be used.

The prediction model learning unit 112 generates a prediction source x and a prediction destination y having the window width W (Step 801). The prediction model configures a three-layer network using a totally connected neural network and executes learning using x and y (Step 802). For the learning, ReLu can be used as an activation function, adam can be used as a gradient method, and the error sum of squares can be used as the loss function. The number of layers in the neural network, the activation function, the gradient method, and the loss function are not limited to the above-described examples.

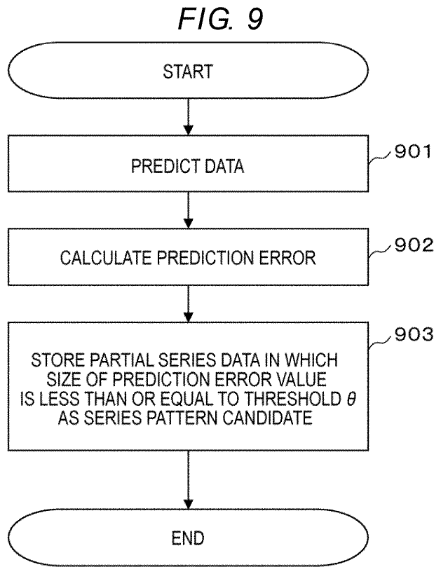

FIG. 9 is a flowchart illustrating an example of a series pattern candidate generation process. The series pattern candidate generating unit 113 generates y\hat{ } using the prediction model f generated by the prediction model learning unit 112 (Step 901), calculates the prediction error using the error sum of squares E=½Σ[(y\hat{ }−y)]\hat{ }2 (Step 902), and stores partial series data in which the size of the prediction error is less than or equal to the threshold θ as a series pattern candidate as illustrated in FIG. 4 (Step 903).

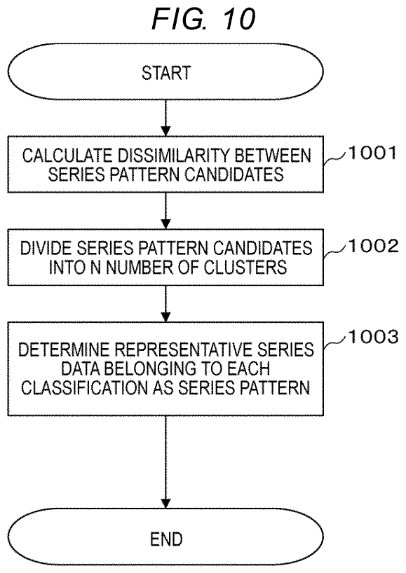

FIG. 10 is a flowchart illustrating an example of a generation process of the series pattern generating unit 114. The series pattern generating unit 114 calculates dissimilarity between series pattern candidates stored in the series pattern candidate generating unit 113 (Step 1001). Next, the series pattern generating unit 114 divides the series pattern candidates into a N number of clusters by hierarchical clustering as illustrated in FIG. 5 (Step 1002). In order to calculate the dissimilarity, dynamic time warping (DTW) is used. However, another distance calculating method such as Euclidean distance or D-DTW may be used. In the embodiment, all the dissimilarity values between series pattern candidates are calculated. However, similarity may be calculated. That is, the similarity may be calculated under conditions regarding the similarity between series pattern candidates.

The series pattern generating unit 114 determines, as a representative series pattern, a series pattern candidate having an intermediate value in data length among series pattern candidates belonging to each of the clusters by comparing the data lengths thereof (Step 1003). As the representative series pattern, a series pattern having the shortest data length or a series pattern having the longest data length may be determined. In addition, when the number of series pattern candidate belonging to a cluster is small (for example, only one series pattern candidate is present) after clustering the series pattern candidates into a N number of clusters, this cluster may be ignored, that is, the presented pattern number is determined to be less than N during the determination of the representative series pattern. Asa result of the clustering, a cluster including only one series pattern candidate may also be present.

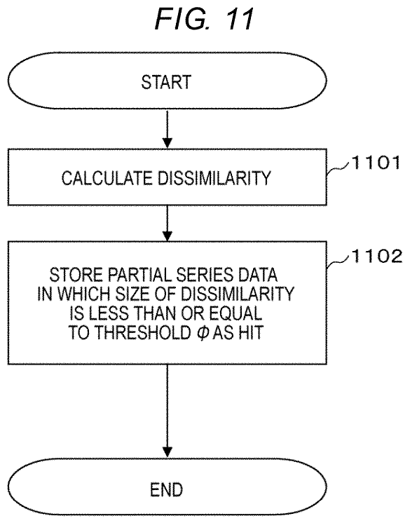

FIG. 11 is a flowchart illustrating an example of a search process of the search query generating unit 115. The search query generating unit 115 calculates all dissimilarity between series pattern candidates stored in the series pattern candidate generating unit 113 (Step 1001). Next, search query generating unit 115 stores, as a search result, search result data including partial series data in which the size of dissimilarity is less than or equal to the threshold ϕ as illustrated in FIG. 6 (Step 1002).

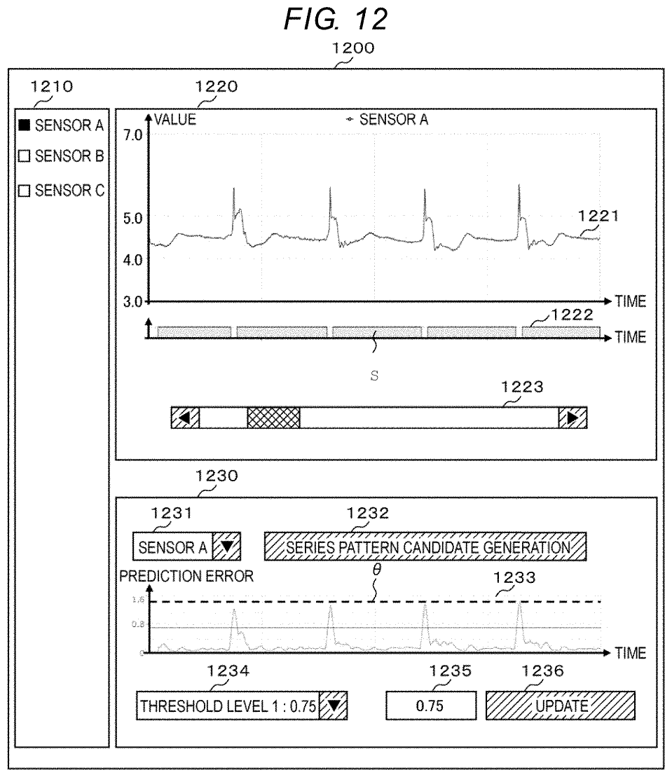

FIG. 12 is a diagram illustrating an example of a series pattern candidate display screen 1200 output from the series pattern candidate generating unit 113. As illustrated in FIG. 12, the series pattern candidate display screen 1200 includes a sensor selection region 1210 for displaying data, a data display region 1220, and a series pattern candidate adjustment region 1230.

The sensor selection region 1210 for displaying data is a region where a list of sensor names included in time series data to be input is displayed.

The data display region 1220 is a region where data regarding the sensor selected in the sensor selection region 1210 for displaying data is displayed. The data display region 1220 includes: a sensor data display region 1221 where time series data of the selected sensor 302 is displayed; a series pattern candidate display region 1222 where a series pattern candidate stored as the partial series data in which the size of the prediction error is less than or equal to the threshold θ is displayed; and a range operation bar (button) 1223 that designates a display range of the time series data or the series pattern candidates.

In the sensor data display region 1221, the values of one or more sensors selected in the sensor selection region 1210 for displaying data are displayed. FIG. 12 illustrates that the sensor A is selected and the series pattern candidate generating unit 113 displays the time series data of the sensor A in the sensor data display region 1221.

In addition, when the time series data is displayed, the series pattern candidate generating unit 113 displays series pattern candidates (in FIG. 12 five candidates) in which the size of the prediction error is less than or equal to the threshold θ among the time series data of the sensor Ain the series pattern candidate display region 1222. When a series pattern candidate in one area of the sensor data display region 1221 or the series pattern candidate display region 1222 is selected (clicked), the series pattern candidate generating unit 113 displays time series data and series pattern candidates in a range including series pattern candidates around the selected series pattern candidate. In FIG. 12, when a series pattern candidate M in an intermediate area in the series pattern candidate display region 1222 is selected, the series pattern candidate generating unit 113 displays time series data and series pattern candidates in a predetermined range including a period around the time of the series pattern candidate M. As a result, the data can be understood while seeing the series pattern candidates positioned around the time of the series pattern candidate S.

In addition, when the range operation bar (button) 1223 is horizontally slid, the series pattern candidate generating unit 113 widens or narrows the time series data displayed in the sensor data display region 1221 and the series pattern candidates displayed in the series pattern candidate display region 1222 in the time direction according to the operation.

The series pattern candidate adjustment region 1230 is a region where the series pattern candidates are adjusted by adjusting the threshold to adjust the granularity of the series pattern candidates. Using the series pattern candidate adjustment region 1230, the user can adjust the Granularity of the partial series data as the series pattern candidates.

The series pattern candidate adjustment region 1230 displays: a target sensor selection region 1231 where sensor data as a target of model learning is selected; a series pattern candidate generation button 1232 that generates series pattern candidates using the time series data of the sensor selected in the target sensor selection region 1231; a prediction error display region 1233 where the prediction error and the threshold θ of the sensor selected in the target sensor selection region 1231 are displayed; a threshold candidate presentation region 1234 where candidates of the threshold θ of the prediction error are presented; a threshold input field 1235 to which the threshold θ is input; and an update button 1236 that updates the threshold θ with the value input to the threshold input field 1235 to update the series pattern candidate display region 1222.

In FIG. 12, the sensor A is selected in the target sensor selection region 1231, and the series pattern candidate generation button 1232 is pressed such that the series pattern candidate generating unit 113 outputs the candidates (the five candidates displayed in the sensor data display region 1221) satisfying the threshold θ of the sensor A among the series pattern candidates to the series pattern candidate display region 1222. In the threshold candidate presentation region 1234, a number of thresholds determined to be the same as the number M of threshold candidates that is determined by the parameter determining unit 116 in FIG. 7 may be displayed. Using the threshold candidate presentation region 1234, the user can easily determine the threshold.

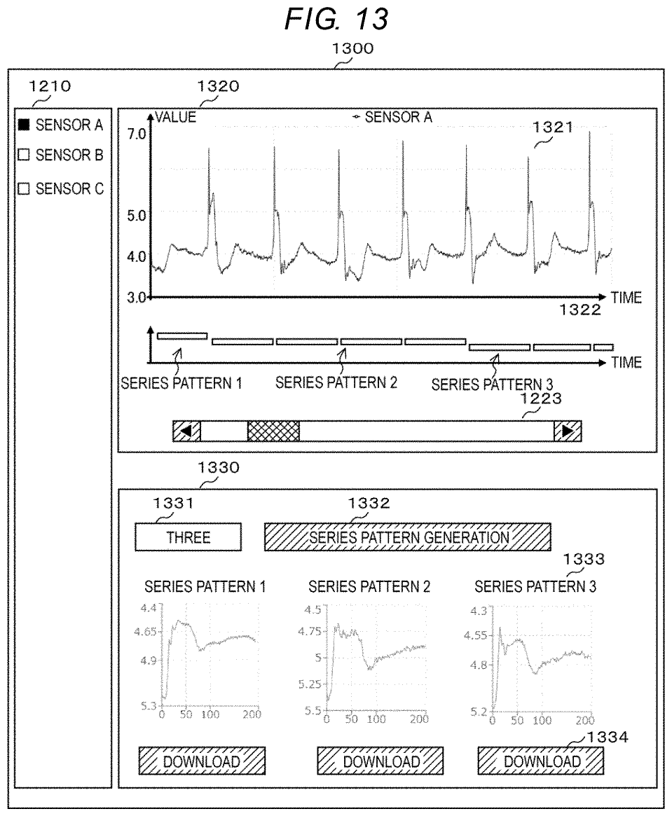

FIG. 13 is a diagram illustrating an example of a series pattern display screen 1300 output from the series pattern generating unit 114. As illustrated in FIG. 13, the series pattern display screen 1300 includes: the sensor selection region 1210 for displaying data that is the same as illustrated in FIG. 12; a sensor data display region 1321 where time series data including partial series data that corresponds to the series pattern candidates generated in the series pattern candidate display screen illustrated in FIG. 12 is displayed; a series pattern display region 1322 where series patterns of the partial series data displayed in the sensor data display region 1321 are displayed; and a range operation bar (button) 1323 that designates a display range of the time series data or the series patterns.

In the sensor data display region 1321, the time series data including the series pattern candidates generated by pressing the series pattern candidate generation button 1232 is displayed. FIG. 13 illustrates that series pattern candidates (series patterns 1 to 3) generated for one sensor (for example, the sensor A) are displayed and the series pattern generating unit 114 displays time series data including partial series data showing the series pattern candidates in the sensor data display region 1321.

In addition, when the time series data is displayed, the series pattern generating unit 114 displays the series pattern candidates (in FIG. 13, the series patterns 1 to 3) in the series pattern display region 1322. When a series pattern in one area of the sensor data display region 1321 or the series pattern display region 1322 is selected (clicked), the series pattern generating unit 114 may display time series data and series pattern in a range including series patterns around the selected series pattern. In FIG. 13, for example, when a series pattern (for example, the series pattern 2) in an intermediate area in the series pattern display region 1322 is selected, the series pattern generating unit 114 displays time series data and series patterns (for example, the series pattern 1 and the series pattern 3) in a predetermined range including a period around the time of the series pattern.

In addition, when the range operation bar (button) 1323 is horizontally slid, the series pattern generating unit 114 widens or narrows the time series data displayed in the sensor data display region 1321 and the series patterns displayed in the series pattern display region 1322 in the time direction according to the operation.

A series pattern adjustment region 1330 is a region where a series pattern to be output is selected and adjusted. The series pattern adjustment region 1330 includes: a pattern number input region 1331 to which the number of series patterns generated by the series pattern generating unit 114 is input; a series pattern generation button 1332 that generates series patterns in the number input from the pattern number input region 1331; a series pattern display region 1333 where the generated series patterns are displayed; and a download button 1335 that downloads partial series data of the Generated series patterns. By inputting and adjusting the pattern number N in the series pattern adjustment region 1330, the number of series patterns to be generated can be changed and adjusted.

In FIG. 13, regarding the sensor A selected in the target sensor selection region 1231, the series pattern generation button 1332 is pressed such that the series pattern generating unit 114 classifies the series pattern candidates generated by the series pattern candidate generating unit 113 into the pattern number of classifications (N=3; the pattern IDs 501 illustrated in FIG. 5=0, 1, 2) and outputs a representative series pattern (the series patterns 1 to 3) from the series pattern candidates belonging to each of the classifications.

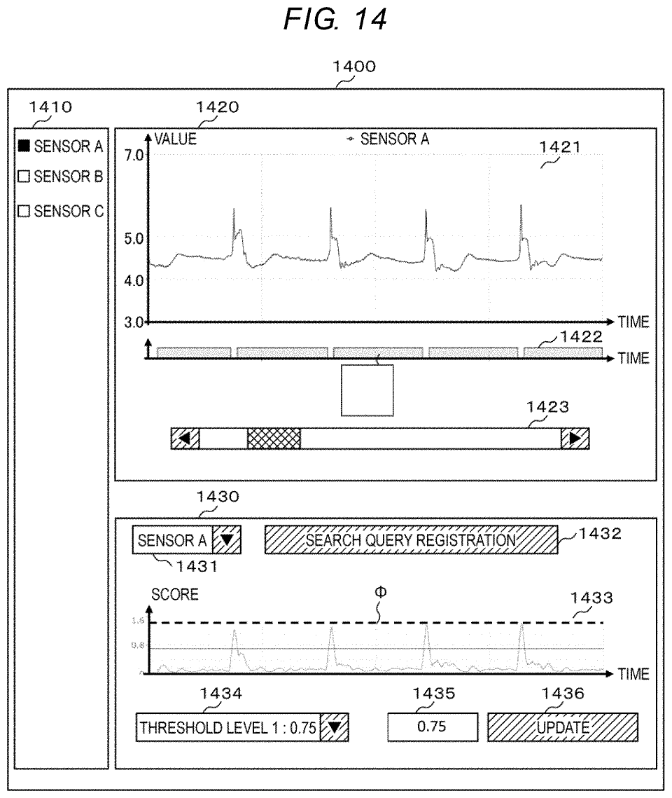

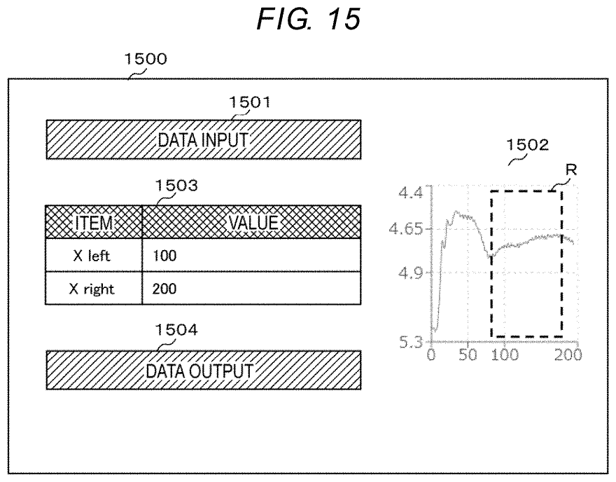

FIG. 14 is a diagram illustrating an example of a data search/extraction screen 1400 displayed by the search result extracting unit 117. As illustrated in FIG. 14, the data search/extraction screen 1400 includes a sensor selection region 1410 for displaying data, a data display region 1420, and a series pattern search adjustment region 1430. The sensor selection region 1410 for displaying data and the data display region 1420 are the same as the sensor selection region 1210 for displaying data and the data display region 1220 illustrated in FIG. 12. Therefore, the description will not be repeated, and the series pattern search adjustment region 1430 will be described.

The series pattern search adjustment region 1430 is a region where a series pattern to be searched is adjusted. The series pattern search adjustment region 1430 displays: a target sensor selection region 1431 where sensor data as a search target selected; a search query registration button 1432 that generates a search query of the series pattern using the time series data of the sensor selected in the target sensor selection region 1431; a series pattern search display region 1433 that displays the threshold ϕ for determining dissimilarity between the time series data and the series pattern of the sensor selected as the search target in the target sensor selection region 1431 and the time series data of the sensor selected as the search target in the target sensor selection region 1431; a threshold candidate presentation region 1434 where candidates of the threshold ϕ are presented; a threshold input field 1435 to which the threshold ϕ is input; and an update button 1436 that updates the threshold ϕ with the value input to the threshold input field 1435 to update a series pattern candidate display screen 1422.

In FIG. 14, the sensor A is selected in the target sensor selection region 1431, and the search query registration button 1432 is pressed such that, using the search query generated by the search query generating unit 115, the search result extracting unit 117 searches the series pattern candidates for candidates (five candidates displayed in the sensor data display region 1221) satisfying the threshold ϕ among the series pattern candidates of the sensor A and outputs the candidates satisfying the threshold ϕ to the series pattern candidate display screen 1422. In the threshold candidate presentation region 1434, a number of thresholds determined to be the same as the number N of threshold candidates that is determined by the parameter determining unit 116 in FIG. 7 may be displayed. In order to calculate the dissimilarity, dynamic time warping (DTW) is used. However, another distance calculating method such as Euclidean distance or D-DTW may be used.

FIG. 15 is a diagram illustrating a search query generation screen 1500 displayed by the search query generating unit 115. As illustrated in FIG. 15, the search query generation screen 1500 includes: a data input button 1501; a series pattern edit display region 1502 where a series pattern registered as the search query is edited and displayed; a range adjustment region 1503 that trims a range that is registered as the search query in the series pattern and adjusts the trimmed range; and a data output button 1504 that outputs the adjusted search query as data.

The data input button 1501 is a button for reading the partial series data of the series pattern downloaded in FIG. 12 and displaying the read partial series data in the series pattern edit display region 1502. For example, in the search query generating unit 115, the search query registration button 1432 illustrated in FIG. 14 is pressed such that the search result extracting unit 117 calls for the search query generating unit 115, and the search query generating unit 115 reads the partial series data of the series pattern downward by pressing the download button 1334 illustrated in FIG. 12 and displays the read partial series data in the series pattern edit display region 1502.

The series pattern edit display region 1502 is a region where the partial series data of the time-series pattern read by pressing the data input button 1501 and the range adjusted in the range adjustment region 1503 are edited and displayed.

FIG. 15 illustrates that the search query generating unit 115 registers, as the search query, a range R in the partial series data of the series pattern displayed in the series pattern edit display region 1502. In addition, when the range is adjusted in the range adjustment region 1503, the search query generating unit 115 highlights and displays the range in the series pattern edit display region 1502 as the range R of the search query. When the data output button 1504 is pressed, the search query generating unit 115 outputs the range that is highlighted and displayed as the search query, for example, in CSV format.

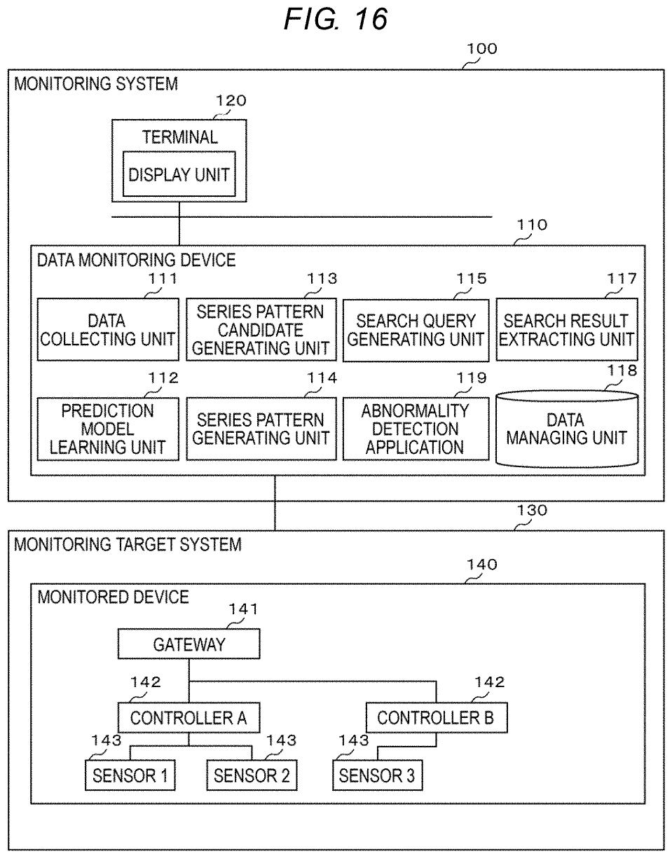

In the monitoring system 100 illustrated in FIG. 1, the parameter determining unit 116 sets various parameters including the threshold θ used for the prediction error and the threshold ϕ used for the search query. However, the time series data changes all the time depending on the environment of the monitoring target system 130. Therefore, it is not necessarily desirable for the user to set these parameters in advance. Therefore, for example, an abnormality detection application 119 of the monitoring system 100 may be provided as illustrated in FIG. 16 such that when an abnormality of the monitoring target system 130 is detect the abnormality detection application 119 may set a parameter determined depending on the kind of the abnormality to the system in order to deal with the abnormality. As a result, a parameter for dealing with an abnormality can be set according to the kind of the abnormality without the user setting the parameter.

In addition, the abnormality detection application 119 may learn a series pattern of the monitored device 140 during a normal state by inputting a series pattern of time series data during a normal state obtained from the sensor of the monitored device 140. The abnormality detection application 119 uses, as learning data, series pattern candidates belonging to the same cluster as that of the series pattern during a normal state generated by the series pattern generating unit 114. As an abnormality detection model for determining whether or not the monitored device 140 is normal, for example, Variational Autoencoder (VAE) or a method of generating a cluster during a normal state and setting data deviating from the cluster as an abnormality can be used.

As described above, according to the embodiment, even when the content of the time series data obtained from the monitored device 140 of the monitoring target system 120 is unclear, the shape of a pattern included in the time series data can be presented to the user, for example, as illustrated in FIGS. 12 and 13. As a result, partial series data in which a characteristic change is shown on the time series data can be presented as a partial series pattern included in the time-series pattern.

In addition, as illustrated in FIGS. 14 and 15, the user generates, as the search query, the partial series data in a desired range in the partial series data based on the series pattern of the presented time series data, and searches the partial series data for the corresponding portion (time) and extracts the corresponding portion. As a result, partial series data having, as a boundary, a portion where a stochastic change is shown in the time series data can be presented to the user.

The present invention is not limited to the embodiment, includes various modification examples, and are not intended to include all the configurations described above. In addition, a part of configurations of one embodiment may be replaced with configurations of another embodiment, and additions of another configurations, deletions, and replacements can be made for a part of the configurations of each of the embodiments.

What is claimed is:

1. A time series data monitoring system comprising:
a series pattern candidate generating unit that generates series pattern candidates included in time series data obtained from a monitored system using the time series data and a prediction model of the time series data; and
a series pattern generating unit that classifies the series pattern candidates generated by the series pattern candidate generating unit and outputs, as a series pattern of the time series data, a candidate satisfying a predetermined condition among the classified series pattern candidates.

2. The time series data monitoring system according to claim
wherein the series pattern candidate generating unit generates, as the series pattern candidates, data in which a prediction error between a prediction result of the prediction model and the time series data is less than or equal to a predetermined threshold.

3. The time series data monitoring system according to claim 1,
wherein the series pattern generating unit outputs a representative series pattern candidate among a predetermined pattern number of classified series pattern candidates based information regarding similarity between the series pattern candidates.

4. The time series data monitoring system according to claim 1,
wherein the series pattern generating unit causes a display unit to display the series pattern of the time series data.

5. The time series data monitoring system according to claim 4,
wherein the series pattern generating unit classifies the series pattern candidates according to the predetermined pattern number input by a user from the display unit.

6. The time series data monitoring system according to claim 2,
wherein the series pattern candidate generating unit outputs, as the series pattern candidates, data in which the prediction error is less than or equal to the predetermined threshold input by a user from a display unit that displays the series pattern of the time series data.

7. The time series data monitoring system according to claim 4, further comprising:
a search result extracting unit that searches the series pattern candidates using a search query for a candidate satisfying a predetermined threshold among the series pattern candidates and causes the display unit to display the candidate satisfying the predetermined threshold.

8. The time series data monitoring system according to claim 7, further comprising:
a search query generating unit that calculates dissimilarity between the series pattern candidates and generates the search query for searching for a series pattern in which a size of dissimilarity is less than or equal to a predetermined threshold.

9. A time series data monitoring method comprising:
allowing a series pattern candidate generating unit to generate series pattern candidates included in time series data obtained from a monitored system using the time series data and a prediction model of the time series data;
allowing a series pattern generating unit to classify the series pattern candidates generated by the series pattern candidate generating unit; and
allowing the series pattern generating unit to output, as a series pattern of the time series data, a candidate satisfying a predetermined condition among the classified series pattern candidates.
